(19) United States
(12) Patent Application Publication
(10) Pub. No.: US 2002/0032685 A1
(43) Pub. Date: Mar. 14, 2002

(54) Database dividing system, method and program

(76) Inventor: Naoki Matsuo, Yokohama (JP)

Correspondence Address: Mattingly, Stanger & Malur, P.C., 104 East Hume Avenue, Alexandria, VA, 22301, US

(21) Appl. No.: 09/810,473

(22) Filed: Mar. 19, 2001

(30) Foreign Application Priority Data
Sep. 13, 2000 (JP) 2000-283777

(51) Int. Cl. G06F 17/30

(52) U.S. Cl. 707/102; 707/2

(57) ABSTRACT

In a multi-dimensional database that may be accessed quickly, the distribution of components of each dimension of the multi-dimensional database is calculated and, based on the calculated distribution, a dimension to be divided is determined. The determined dimension is divided into a plurality of dimensions and data is stored in the database for each dimension.

### BACKGROUND OF THE INVENTION

The present invention relates to a database management system, and more particularly to data division suitable for quickly aggregating and searching multi-dimensional data.

In a relational database management system, data division algorithms, such as hash division and range division, are used for allocating data when parallel processing is used (DeWitt, D., et al., ‘The Gamma Database Machine Project’, IEEE Transactions on Knowledge and Data Engineering, vol. 2, no. 1, pp. 44-63, 1990). Data may be stored in several ways so that a multi-dimensional data search may be made efficiently. In one method, data is linearly arranged in nesting order of dimension coordinates in the same way array data is arranged in memory by computer language. In another method, assuming that multi-dimensional data is divided into a part where data with valid values is coarsely distributed and a part where data with valid values is densely distributed, storage areas are allocated only to non-null sub-spaces and, in addition, a pointer array is applied to the sub-spaces with the pointers in the array pointing to the storage areas (U.S. Pat. No. 5,359,724).

### SUMMARY OF THE INVENTION

To process multi-dimensional databases in parallel with conventional relational databases, data must be divided. However, when dividing multidimensional data according to the hash division algorithm or range division algorithm, multiple dimensions are not considered. This is because both the hash division algorithm and the range division algorithm perform processing while considering one dimension only. Therefore, when a dimension that is not considered is found, aggregation or slice processing for that dimension involves a large overhead.

Arranging data in dimension nesting order has an advantage that the pages, each storing therein data, may be addressed through multi-dimensional coordinate calculation. However, this method has some problems. For example, valid data cannot be compressed efficiently according to the density (coarse/fine) of data distribution. In addition, the physical distance between data items, which are adjacent each other in the data space, depends largely on a dimension; that is, clustering becomes biased. Another problem with the method according to U.S. Pat. No. 5,359,724 is that the data distribution density must be clearly identified.

To solve the above problems, the distribution of the elements in each dimension is calculated and a dimension to be divided is determined according to the distribution.

That is, a dimension in which elements will be evenly distributed is divided to evenly distribute the elements.

### BRIEF DESCRIPTION OF THE DRAWINGS

FIG. 1 is a diagram showing the system configuration.

FIG. 2 is a diagram showing the configuration of a management unit.

FIG. 3 is a diagram showing an example of input data.

FIG. 4 is a diagram showing an example of a dimension element name coordinate ID table.

FIG. 5 is a diagram showing the configuration of a preprocessor.

FIG. 6 is a diagram showing the configuration a data division processor.

FIG. 7 is a diagram showing the overall processing flow of the management unit.

FIG. 8 is a diagram showing an example of a dimension member quantity table.

FIG. 9 is a diagram showing the concept of multi-dimensional data.

FIG. 10 is a diagram showing an example of data division.

FIG. 11 is a diagram showing an example of a division width table.

FIG. 12 is a diagram showing the concept of multi-dimensional data that has been divided.

FIG. 13 is a diagram showing an example of a division table.

FIG. 14 is a diagram showing the processing flow of a search request/result processor.

FIG. 15 is a diagram showing the system operation in which databases are reorganized.

### DESCRIPTION OF THE EMBODIMENTS

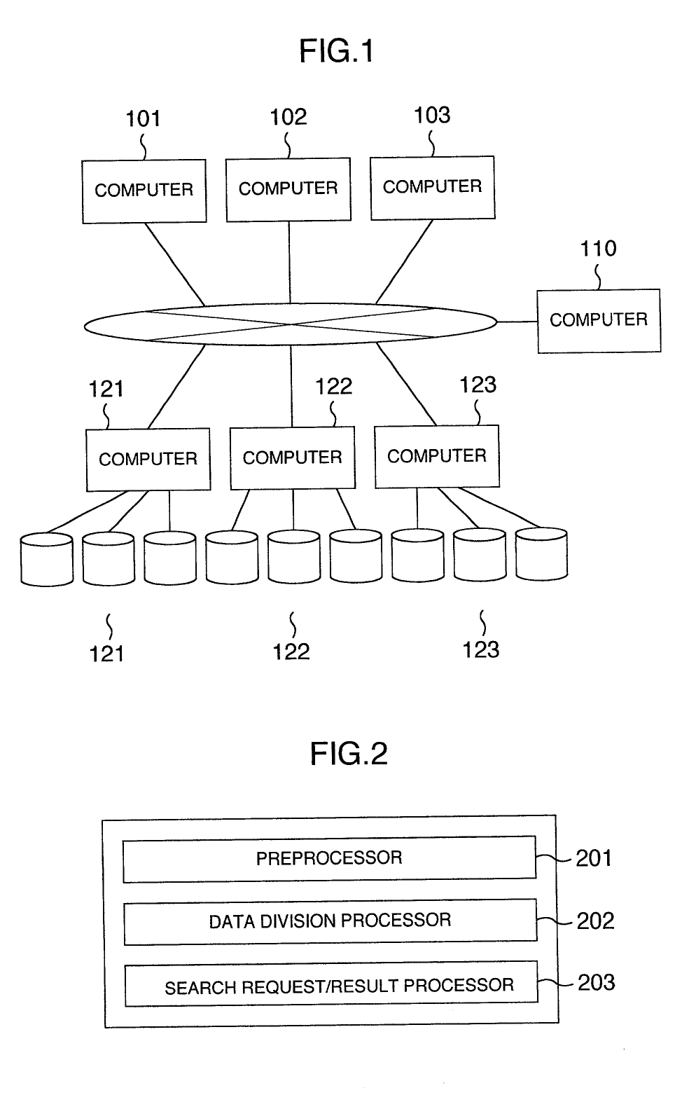

FIG. 1 shows the configuration of a system in which multi-dimensional databases are used. This system has a plurality of computers 101-103, 110, and 121-123 connected to a network. Each computer has a processor such as a CPU. Storage units 131-133 such as hard disks, which contain databases, are connected to the computers 121-123. The computers 101-103 are client computers which, upon receiving a search request, send the request to the computer 110. In response to the received search request, the computer 110 identifies one of the computers 121-123 that manages the corresponding database and sends the search request to the identified computer. The computer that has received the request searches the database based on the search request. The search result is sent to the computer 110, which collects the search result and sends it to the client computer from which the request was sent.

When building a database, this system analyzes data distribution for optimum data division. This is done primarily by the computer 110.

FIG. 2 shows the configuration of the computer 110. The computer 110, which controls database management computers 121-123, comprises a preprocessor 201, a data division processor 202, and a search request/result processor 203.

Each component will be described. The main function of the preprocessor 201 is to generate a dimension element name coordinate ID table that will be used by the data division processor 202.

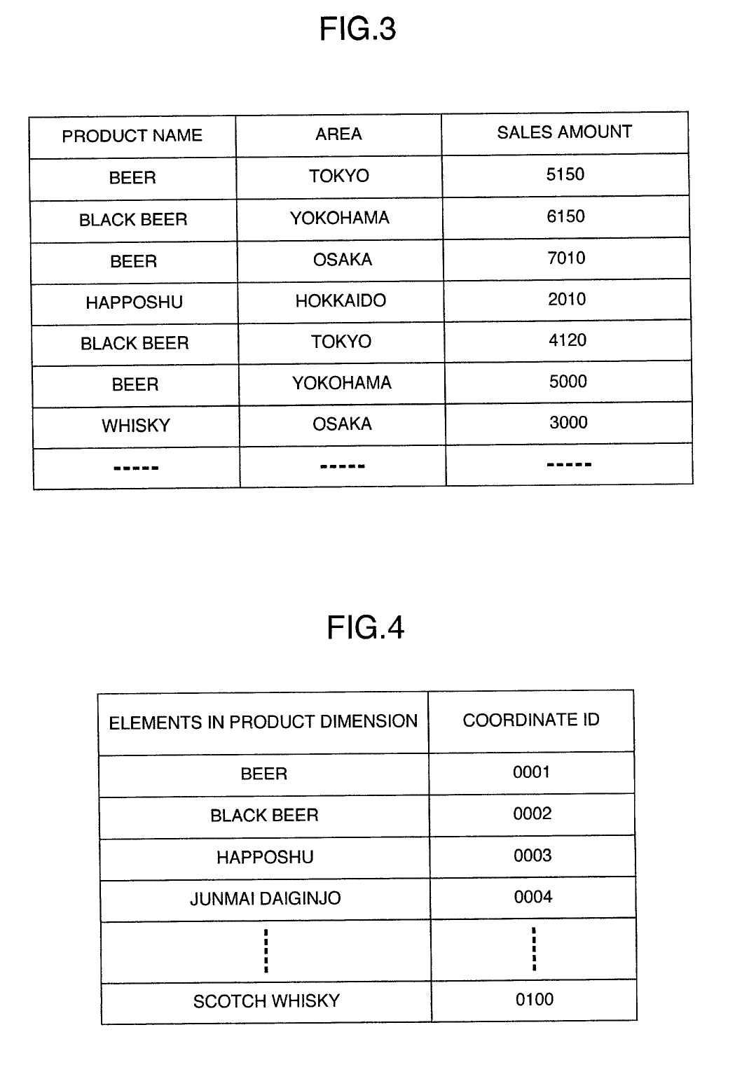

FIG. 3 shows an example of input data composed of dimension names such as “product name” and “area” and dimension element names such as “beer”, “black beer”, “Tokyo”, and “Yokohama”. Dimension elements represented usually in natural language or code numbers assigned to products, such as those described above, cannot be represented in multidimensional space. To solve this problem, the dimension element name coordinate ID table, such as the one shown in FIG. 4, is generated to associate dimension elements with IDs corresponding to the coordinates.

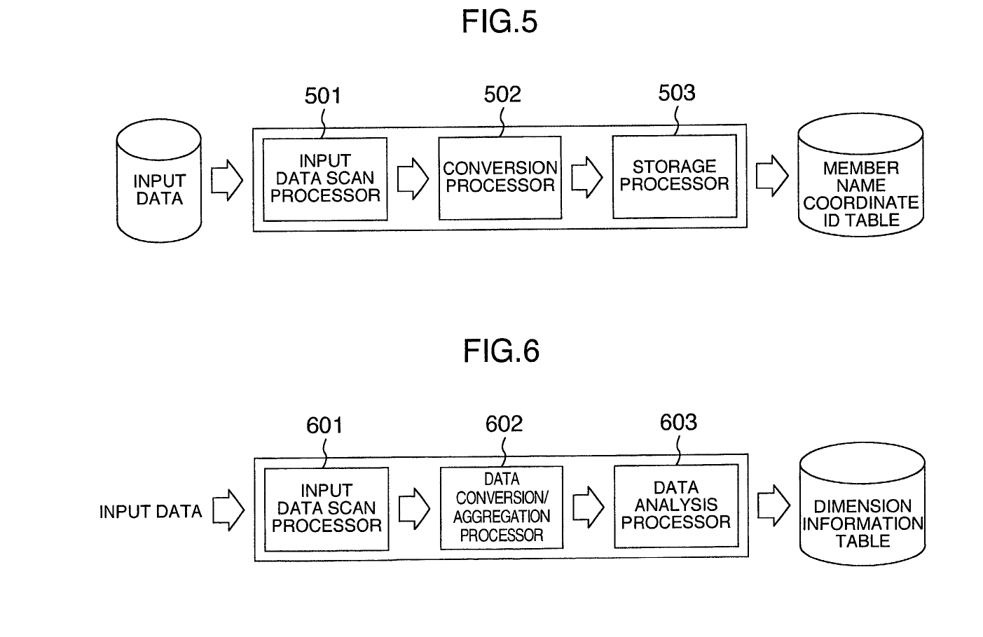

FIG. 5 shows the configuration of processing performed by the preprocessor 201. An input data scan processor 501 reads data, and a conversion processor 502 selects dimension elements from the input data. The conversion processor 502 extracts dimension elements from predetermined dimension names and assigns an ID to each element. A storage processor 503 stores the result in a storage unit. This sequence of steps result in the dimension element name coordinate ID table shown in FIG. 4.

Next, the data division processor 202 will be described. The data division processor 202 reads data, which will be used to form a multi-dimensional database, determines a dimension whose data is to be divided, and divides data of the determined dimension.

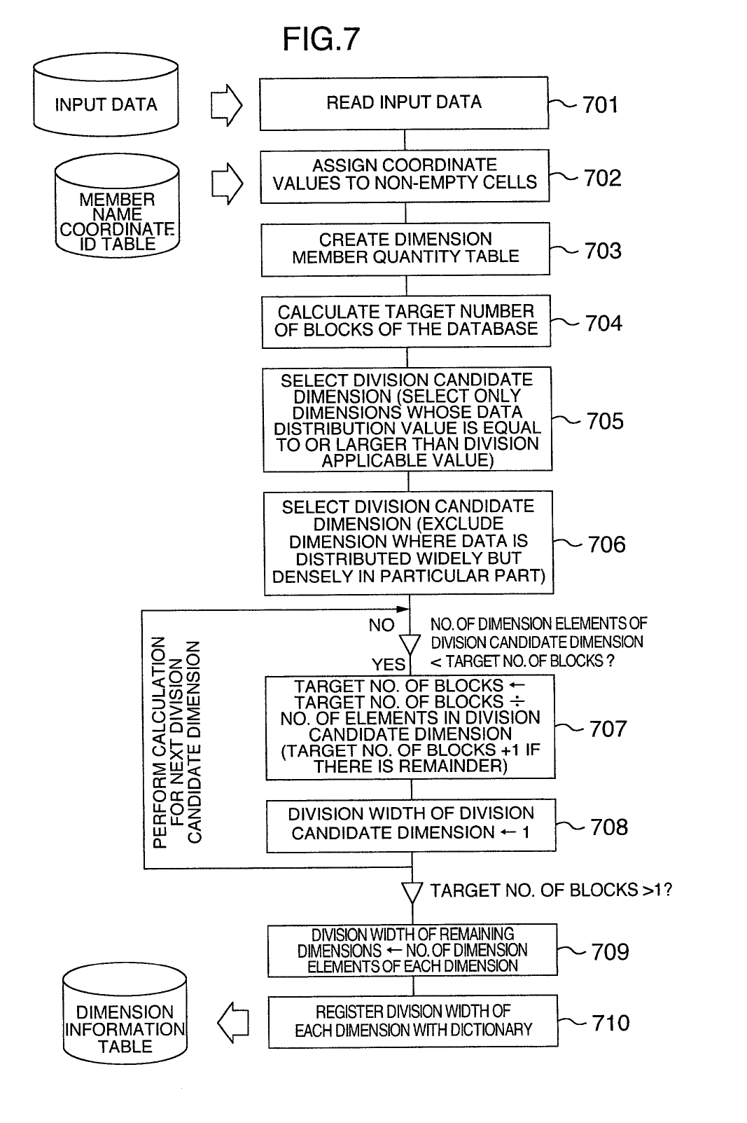

FIG. 6 shows the configuration of processing performed by the data division processor 202, and FIG. 7 is a flowchart showing the processing of the data division processor 202.

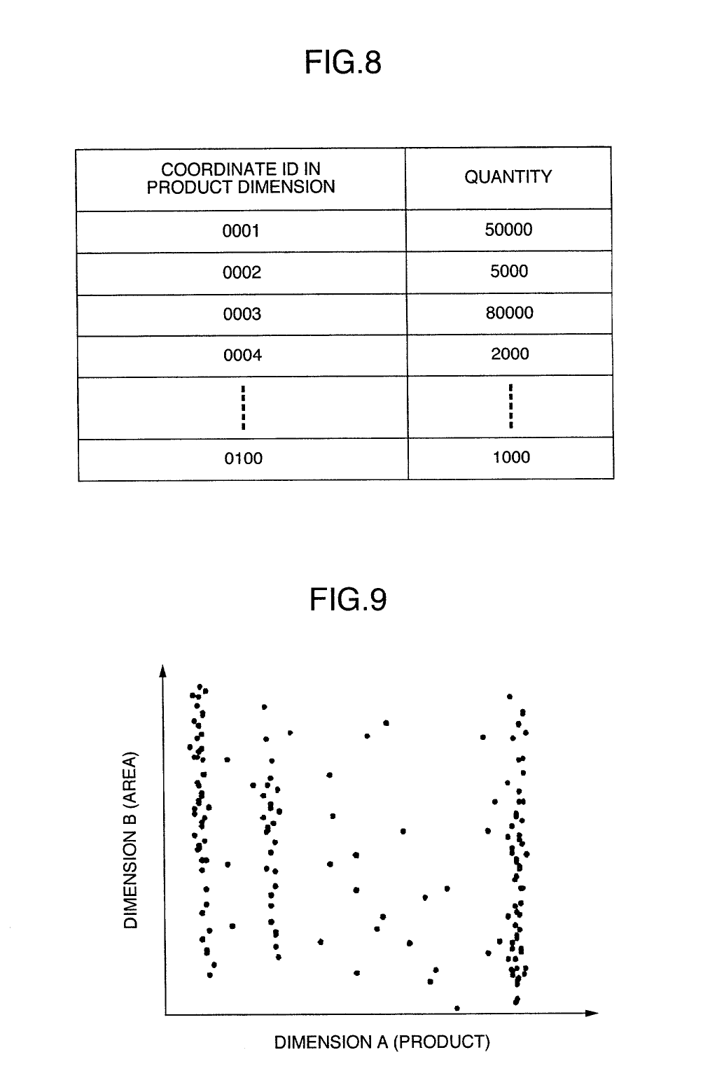

An input data scan processor 601 shown in FIG. 6 reads data from the client computers 101-103 (step 701 in FIG. 7). Upon receiving data from the input data scan processor 601 shown in FIG. 6, a data conversion/aggregation processor 602 assigns a coordinate value to each valid or non-empty cell (step 702 in FIG. 7). A coordinate value is assigned according to the dimension element name coordinate ID table shown in FIG. 4. For example, when “happoshu” which is one of dimension elements in the product dimension is received, the coordinate ID in the product dimension is converted to 0003 according to the dimension element name coordinate ID table shown in FIG. 4. In this way, received dimension elements are converted to coordinate IDs. In addition, the processor counts converted coordinate IDs. That is, the processor counts the number of times each product name—“beer”, “black beer”, “happoshu”, etc.,—appears in the product dimension. The processor counts the number of times each dimension element appears in this manner to generate a dimension member quantity table such as the one shown in FIG. 8. Similarly, the processor generates a dimension member quantity table for each of other dimensions (for example, the dimension of “area”).

For illustrating an embodiment of the present invention, an example of a multi-dimensional database will now be described. FIG. 9 shows the concept of a multi-dimensional database composed of dimension A that is the dimension of “product” and dimension B that is the dimension of “area”. Each black dot in FIG. 9 indicates an effective cell, with its value representing the sales amount. That is, this multidimensional database is composed of sales data by product and sales data by area.

A data analysis processor 603 shown in FIG. 6 divides a multi-dimensional database according to the generated dimension member quantity table. First, the processor determines the number of data items to be stored in the database. The number of data items is determined by counting all non-empty cells or is supplied externally by the user. In the description below, it is assumed that the number of data items to be stored in the multi-dimensional database shown in FIG. 9 is 300,000 which is supplied externally by the user. This number may be supplied by the client computers 101-103 or directly by the computer 110.

Next, the number specified above is divided by the target number of non-empty cells for each block. The target number of non-empty cells is specified for the system by the user or is defined as the default value (depending on the installation condition). In the description below, it is assumed that the target number of non-empty cells is not specified externally by the user but is defined as 50,000 that is the default value.

The target number of blocks is calculated in this example as 300000/50000=60000 (step 704 in FIG. 7).

Next, the data analysis processor 603 selects a dimension whose data is to be divided. First, for all dimensions, the processor sorts the dimension member quantity table, shown in FIG. 8, in numeric order. Using the sorted result, the number of dimension elements in the dimension are added up, beginning with the largest number of elements, to such “a degree at which most non-empty cells (system default value or user specified value) are included”. This “degree at which most non-empty cells are included”, for example, 90% to 95%, is set to exclude exceptions. Then, the number of elements in the dimension at the time the “degree at which most non-empty cells are included” is reached is divided by the number of all elements in the dimension. The resulting value indicates how data is distributed on the axis of the dimension. That is, the smaller the data distribution numeric value is, the more locally the data is located in the dimension. Conversely, the closer to 1 the data distribution numeric value is, the more evenly the data is located in the dimension. In the description below, it is assumed that the data distribution numeric value of the product dimension in FIG. 9 is 0.1 and that the data distribution numeric value of the area dimension is 0.8. When the data distribution numeric value is equal to or larger than the division applicable value (system default value or user specified value), the data in the dimension is divided. That is, if the division applicable value is 0.6, the data in the area dimension, whose data distribution value is 0.8, is a division candidate. At this time, if the data distribution numeric value is smaller than the division applicable value in all dimensions, the division candidates are selected sequentially with the dimension with the largest data distribution numeric value first (step 705 in FIG. 7).

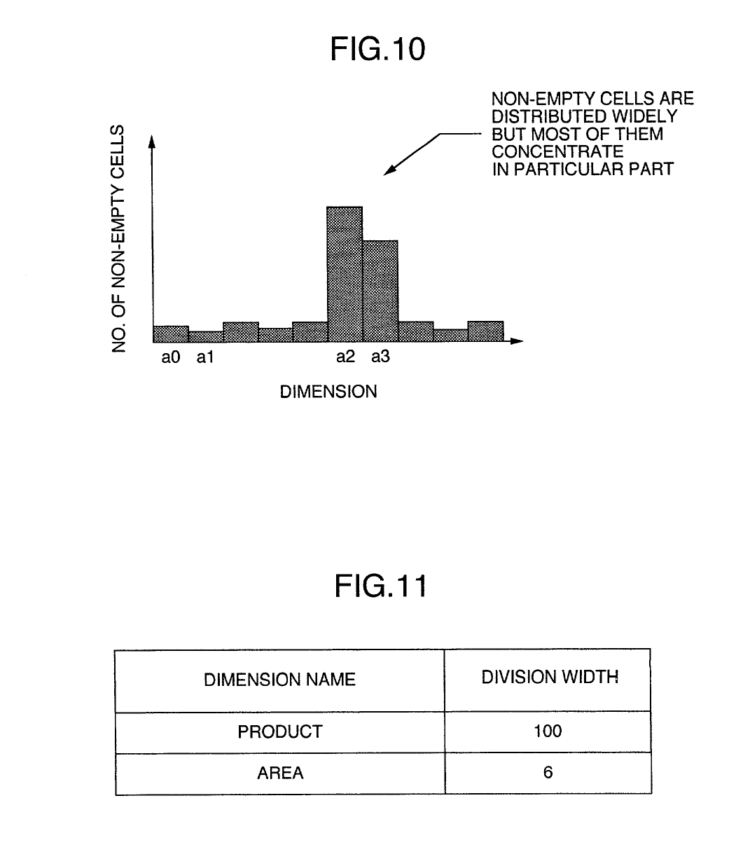

In the example shown in FIG. 9, the area dimension must be divided into six. In addition, the system adds up the highest-frequency non-empty cells in each dimension for a predetermined ratio of dimension elements to all the dimension elements. If the resulting value is equal to or larger than a predetermined value, the system excludes the dimension from candidates for division. The system does this processing to exclude a case, such as the one shown in FIG. 10, in which non-empty cells exist in most dimension elements but actually the data distribution is biased. A dimension whose data is distributed as shown in FIG. 10, if selected for division, would affect access efficiency because data concentrates in particular blocks. This processing is done in step 706 in the flowchart shown in FIG. 7.

Next, the data analysis processor 603 shown in FIG. 6 divides the division candidate dimension. In the example in FIG. 9, the “area” dimension that was selected as the division candidate is divided by six.

The number of dimension elements in the area dimension is divided by six with the result rounded up to the nearest integer. For example, if the number of area dimension elements is 35 in the example shown in FIG. 9, the division width is 6. When the target number of blocks is large, the number of elements of a plurality of division candidate dimensions is divided. (Target number of blocks) is divided by (number of division candidate dimension elements), and the resulting value is used as the new target number of blocks (add 1 if there is a remainder). The division width of the division-candidate dimension is set to 1. The division width of each dimension is stored in the division width table shown in FIG. 11.

If the number of elements of the division candidate dimension is larger than the target number of blocks, the same processing is repeated for the updated target number of blocks and the next division candidate dimension. If division candidate dimensions are insufficient, the dimensions with a data distribution value lower than the division applicable value are divided beginning with the dimension with the largest data distribution value. For the remaining dimensions, the number of elements of each dimension is used as the division width (steps 707-709 in FIG. 7).

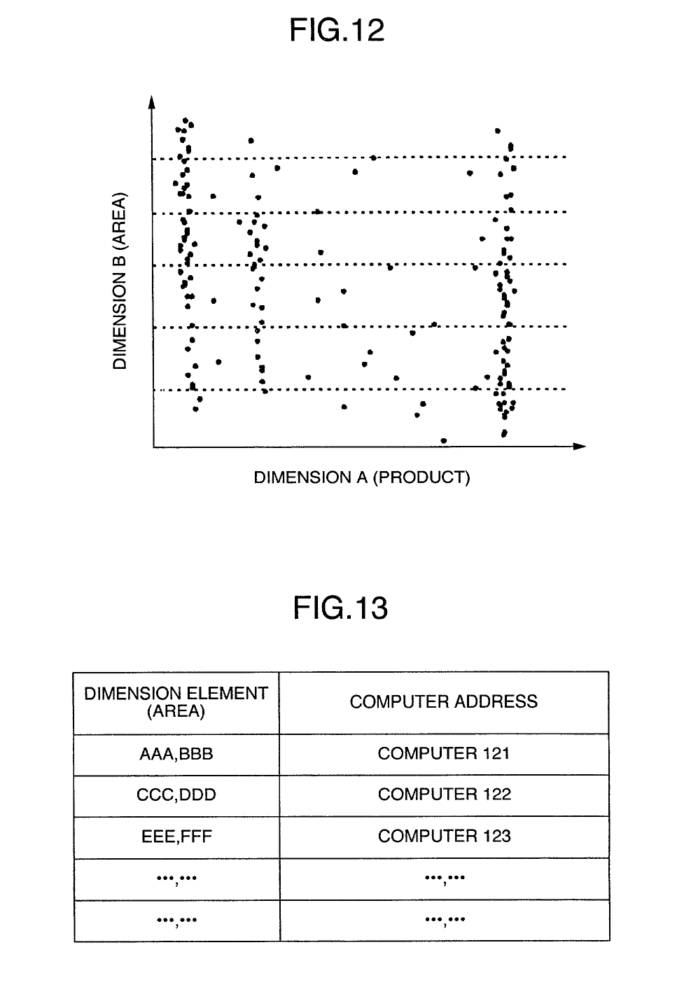

FIG. 12 shows the result of the above processing. The broken lines in this figure indicate divisions. Dividing the elements in the “area” dimension, as shown in this figure, allows data to be allocated evenly among blocks. This evenly-distributed data allocation, in turn, allows access to the database to be distributed, thus increasing the search speed.

The data analysis processor 603 allocates the blocks, generated as the division, to the computers 121-123 that are database management units. This allocation result is managed in the division table shown in FIG. 13.

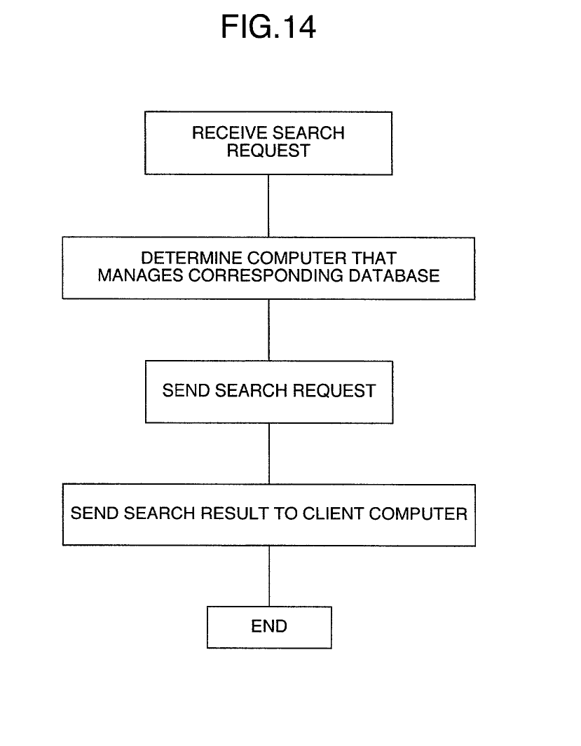

Next, the search request/result processor 203 shown in FIG. 2 will be described. FIG. 14 is a flowchart showing the processing of the search request/result processor 203. In response to a search request from one of the client computers 101-103 (step 1401), the processor compares the search request with the division table shown in-FIG. 13 to determine the computer that manages the database in which the requested data is stored (1402). Then, the processor sends the address of the determined computer and the search request to the network (1403). After a specified time, the processor receives, over the network, the search result from the computer to which the request was sent and then sends the search result to the client computer from which the request was received (1404).

Although, in the embodiment above, the management computer 110 converts received data and divides data, the client computers 101-103 may also convert and aggregates received data.

In this case, the client computers 101-103 must have the function of the preprocessor 201 shown in FIG. 2 and the functions of the input data scan processor 501 and the conversion/aggregation processor 502 shown in FIG. 5. In addition, the management computer 110 has a data merge processor that is a new function. This data merge processor receives the dimension member quantity tables for all the dimensions from the client computers 101-103, merges the received dimension member quantity tables into one, and creates a dimension member quantity table for all input data in the storage unit. The data merge processor counts all non-empty cells while merging data. The resulting merge information is similar in format to the dimension member quantity table shown in FIG. 8. The merge processor passes the merged information and the total number of non-empty cells to the data analysis processor 603 shown in FIG. 6.

This configuration reduces the processing load of the computer 110 and therefore divides data more quickly.

This processing may also be done after the computers 121-123 have created databases.

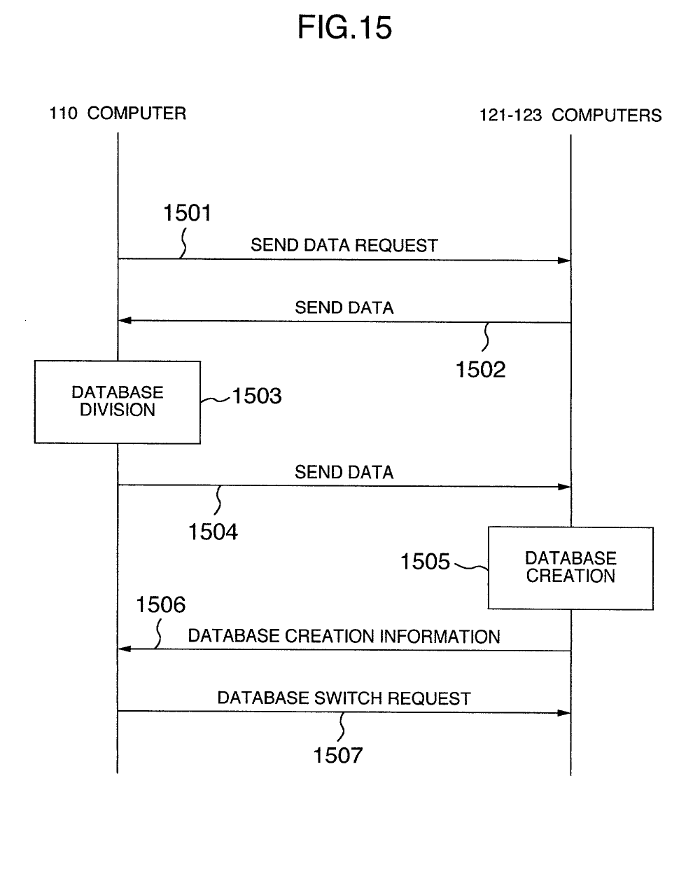

FIG. 15 shows the overall processing of reorganization in which the databases created by the computers 121-123 are reorganized.

The computer 110 requests the computers 121123 to send data (1501). The computers 121-123 send items, each composed of data constituting the databases, dimension names, and dimension element names, to the computer 110 (1502). The computer 110 creates the dimension element name coordinate ID table shown in FIG. 4 from the received data and executes the processing shown in FIG. 7 to create the division table shown in FIG. 13 (1503). The computer 110 sends data to the computers 121-123 according to the created division table (1504). The computers 121-123 each create new databases from the received data (1505). After creation of databases, the computers 121-123 send information to the computer 110 saying that databases have been created (1506). Upon receiving the database creation information saying that the databases have been generated in the computers 121-123, the computer 110 sends a database switch request to the computers 121-123 (1507).

This makes it possible to generate a multidimensional database that may be accessed efficiently even while databases are in continuous operation.

If data is exchanged among the computers 121123 according to the table shown in FIG. 13, the dimension names and the number of dimension elements associated with the data exchange may be sent to the computer 110 in step 1504 in FIG. 15 in which data is sent. This reduces the amount of data transferred between the computer 110 and the computers 121-123 and therefore reduces the network load.

Although a database is divided based on the dimension elements and the number of dimension elements in this embodiment, the dimension elements and access requests to the dimension elements may be managed in the computer 110 for database reorganization. More specifically, the quantity of dimension elements described above may be replaced with the number of accesses to implement this processing.

The method according to the present invention makes it possible to distribute the load at search time and to speed up search processing.

While the preferred form of the present invention has been described, it is to be understood that the present invention is not limited to the embodiments but that modifications will be apparent to those skilled in the art without departing from the spirit of the present invention.

1. A data division method for dividing data and storing the divided data into a plurality of databases, said method comprising the steps of:
assigning a sequence of coordinate values to dimension elements of each dimension;
finding a distribution of non-empty cells in a multi-dimensional database, with a set of the coordinate values of the dimension elements as cell coordinates of the data, to divide the data according to the distribution; and
storing the divided data into the databases.

2. A data division method for dividing data and storing the divided data into a plurality of databases, said method comprising the steps of:
assigning coordinate values in each dimension to blocks in each dimension;
identifying each block with a set of block coordinate values in the dimension as a block coordinate of the block;
calculating a number of blocks obtained by dividing each dimension; and
correcting a number of divisions of each dimension to reduce the number of blocks.

3. A database management device storing data into a plurality of databases, identifying a database in response to a search request, and sending the search request to the identified database,
wherein said database management device has a data division function to find a distribution of each item of received data, to divide the data based on an item whose data is evenly distributed, and to store the divided data into the databases.

4. A database management device storing data into a plurality of databases, identifying a database in response to a search request, and sending the search request to the identified database,
wherein said database management device has a data division function to find an access distribution of each item of received data, to divide the data based on an item whose data is evenly distributed, and to store the divided data into the databases.

5. A database management device storing data into a plurality of databases, identifying a database in response to a search request, and sending the search request to the identified database,
wherein said database management device assigns coordinate values in each dimension to blocks in each dimension, identifies each block with a set of block coordinate values in the dimension as a block coordinate of the block, calculates a number of blocks obtained by dividing each dimension, and corrects a number of divisions of each dimension to reduce the number of blocks.
